(19) United States
(12) Patent Application Publication
(10) Pub. No.: US 2007/0116240 A1
(43) Pub. Date: May 24, 2007

(54) Systems and methods for qualification-based intelligent call routing

(75) Inventors: Peter M. Foley, Knoxville, TN (US); Paul J. Ford, Knoxville, TN (US); Timothy S. Hunter, Knoxville, TN (US); Thomas M. Farrell, Knoxville, TN (US); Terrence W. Moore, Knoxville, TN (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: CAPITAL ONE FINANCIAL CORPORATION

(21) Appl. No.: 11/258,938

(22) Filed: Oct. 25, 2005

(51) Int. Cl. H04M 3/00

(52) U.S. Cl. 379/265.02

(57) ABSTRACT

Systems and methods are provided for routing calls. The calls may be routed based on criteria. In one example, the criteria include a requirement that an agent be licensed. The licensing requirement may be determined, for example, based on the telephone number of a caller. The caller may specify additional criteria. The system may determine, from among agents meeting the licensing criterion and the customer-specified criteria, which available agent has a highest rating. The call may be routed to the highest-rated available agent meeting the licensing requirement and the customer-specified criteria.

### TECHNICAL FIELD OF THE INVENTION

This invention relates in general to call routing and, more particularly, to systems and methods for intelligent call routing which may be based at least partially on applicable qualifications of a call agent.

### BACKGROUND

In many industries, sales of goods or services are made to customers by sales associates. In certain industries, sales associates may work in call centers and conduct sales transactions over telecommunication systems. Systems are available for routing incoming calls (e.g., from customers) to call center agents. For example, a call center call routing system may route an incoming call to the next available agent in the call center.

Sales of certain products require the seller to be licensed in a particular jurisdiction. For example, a state in which a sale is made might require the seller to have a license in that state. Different products may require different licenses.

### SUMMARY

In accordance, with certain embodiments of the present invention, systems and methods are provided for routing calls, for example, from callers to agents in a call center environment. According to one embodiment, a call routing system includes at least one processor and at least one memory electronically coupled to the processor. The at least one memory is operable to store agent data indicative of one or more qualifications of a plurality of agents. The system also includes at least one call router operable to route calls with callers to one or more of the plurality of agents based on at least one transaction criterion associated with the respective calls. The at least one call router is operable to match the at least one transaction criterion to agent data of at least one of the plurality of agents having at least one qualification corresponding to and meeting the at least one transaction criterion.

According to another embodiment, a method is provided for routing calls. The method includes receiving a first transaction criterion. The method also includes comparing the first transaction criterion to one or more stored qualification records associated with one or more agents. The method further includes determining, according to the one or more qualification records, which of the one or more agents meets the first transaction criterion. The method also includes determining which agent, from among the agents meeting the first criterion, has a highest rating. The method further includes routing a call to the highest-rated agent meeting the first criterion.

According to another embodiment, a method is provided for routing calls. The method includes automatically determining a jurisdiction of a caller. The method includes automatically determining a license requirement associated with the jurisdiction. The method also includes automatically identifying, from a plurality of agents, one or more agents meeting the licensing requirement. The method further includes automatically routing the call to one of the one or more agents meeting the licensing requirement.

According to another embodiment, a method is provided for routing calls. The method includes establishing a first parameter. The method also includes identifying a plurality of values associated with the first parameter. The method also includes ranking the plurality of values. The method also includes determining an overall rate of a plurality of agents, the overall rate being associated with the first parameter. The method also includes determining a first subrate of a first subset of the plurality of agents, the first subrate being associated with a first subset of the plurality of values. The method further includes routing a call to an agent among the first subset of agents based on the first subrate.

According to another embodiment, a method is provided for routing calls. The method includes establishing a first plurality of values associated with a first parameter. The method also includes establishing a second plurality of values associated with a second parameter. The method also includes associating the second plurality with the first plurality to determine an overall rate. The method also includes associating a first subset of the second plurality with a first subset of the first plurality to determine a first subrate. The method also includes comparing the first subrate to the overall rate. The method further includes routing a call based on the comparison.

Various embodiments of the present invention may benefit from numerous advantages. It should be noted that one or more embodiments may benefit from some, none, or all of the advantages discussed below.

One advantage is the automation of complex routing determination methods. Another advantage is the ability to automatically route calls to agents meeting certain licensing requirements. Another advantage is the determination and prioritization of transaction criteria to determine optimal call routing. Another advantage is the ability to automatically differentiate between mandatory and optional transaction requirements in a call routing environment. Another advantage is connecting callers with highest-rated agents meeting one or more mandatory criteria. Other advantages will be readily apparent to one having ordinary skill in the art from the following figures, descriptions, and claims.

### BRIEF DESCRIPTION OF THE DRAWINGS

For a more complete understanding of the present invention and for further features and advantages, reference is now made to the following description, taken in conjunction with the accompanying drawings, in which:

FIG. 1 illustrates an example system for routing calls in accordance with an embodiment of the invention;

FIG. 2 illustrates an example method for routing calls in accordance with an embodiment of the invention; and

FIG. 3 illustrates another example method for routing calls in accordance with an embodiment of the invention.

### DETAILED DESCRIPTION

Certain embodiments of the present invention are generally directed to providing systems and methods for routing calls. The call routing may be associated with, for example, routing calls to and/or from customers in a call center environment. The system may include a router, which can route calls based upon specified agent criteria. The router compares the specified criteria to agent qualifications to determine which agents are suited to handle the respective call. In one embodiment a criterion is a requirement that the agent have a license to sell a product which is the subject of the call.

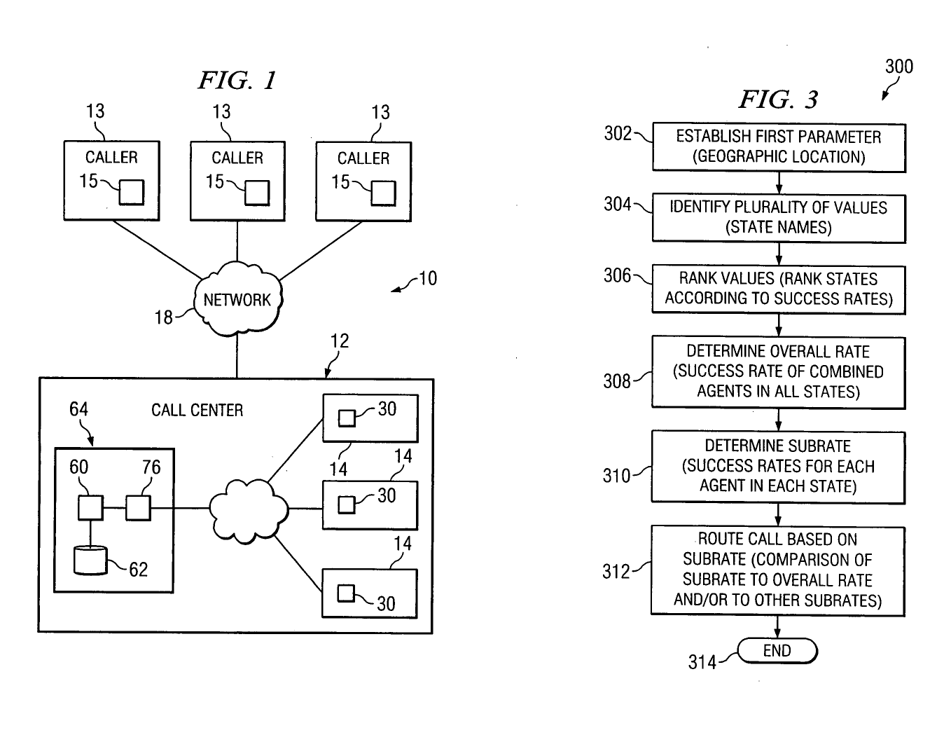

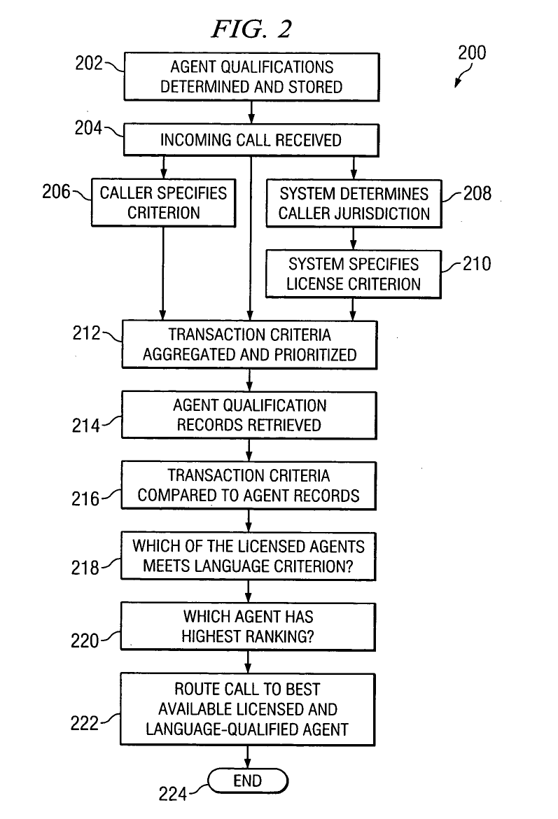

Example embodiments of the present invention and their advantages are best understood by referring now to FIGS. 1 and 2 of the drawings, in which like numerals refer to like parts.

FIG. 1 illustrates an example embodiment in which a call routing system 10 is provided for routing calls based at least partially on one or more qualifications of agents handling calls with customers. System 10 includes one or more callers 13, a communications network 18 and a call center 12. The call center 12 includes one or more agents 14 and a call routing platform 64. The call routing platform 64 includes at least one processor 60 and at least one memory 62. The call routing platform 64 also includes a call router 76.

Callers 13 may be, for example, customers or potential customers. However, callers 13 may be any appropriate individual, entity, or automated system. In the illustrated embodiment, caller 13 is an individual consumer, but the invention is not so limited. Callers 13 may be conducting any suitable transaction with one or more agents 14 including, but not limited to, the purchase of goods or services. Callers 13 may be engaging, for example, in transactions involving the purchase of services being promoted by the agents. In another example alternative, callers 13 may be contacting agents for support concerning products (e.g., computers systems or other goods, telecommunications services, accounts, policies, etc.), which are handled by the agents 14. In at least one embodiment, callers 13 are conducting transactions involving the purchase of insurance policies. In other example embodiments, however, callers 13 may be applying for credit card accounts or other accounts, purchasing real estate, purchasing medical services, receiving medical advice, receiving legal advice, asking for information about products, seeking support for problems with products or services, etc.

Each caller 13 may include an interface 15 for enabling the caller to communicate with agents 14 and/or call center 12 or any of its components. Callers 13 may include any suitable communication device (not expressly shown) such as a telephone, mobile phone, personal data assistant, or computer, for communicating with the various elements of system 10. Interface 15 may be a component of the communication device utilized by caller 13. In some embodiments, interface 15 is the communication device. Preferably, interface 15 allows caller 13 to engage in transactions and to transmit information (e.g., transaction criteria, sales information, identification information, etc.) to agents 14 and/or call center 12.

Agents 14 include any appropriate individuals, entities, or automated systems capable of interfacing with callers to conduct transactions. In the illustrated embodiment, agents 14 are individuals located at call center 12. Agents 14 can be located in any suitable place including being co-located with the call center 12. However, it should be understood that agents 14 may be remotely located.

The term “transaction” is intended to encompass any transaction with the caller 13. For example, the transaction may be a sale, or the customer's confirmation of, or commitment to make, a purchase. However, the invention is not limited to sales. Any exchange (e.g., currency or other financial consideration, or information) between a caller 13 and an agent 14 may qualify as a transaction.

Agent 14 may comprise a sales platform. For example, agent 14 may comprise one or more computers (not expressly shown). Preferably, each agent 14 includes an interface 30 for enabling an operator (e.g., the agent) to communicate with the other components of call center 12 and/or with callers 13. The interface may comprise a graphic user interface, for example. Any suitable interface may be used. Interface 30 may be used to conduct sales transactions and/or other customer transactions. Interface 30 may also be used to connect a caller 13 to call center 12 or its components. Interface 30 may also be used to transmit information between agents 14 and the other components of system 10.

Callers 13 and agents 14 may conduct transactions over any suitable communication link such as, for example, communications network 18. However, the transactions may be conducted over a communication link separate from communications network 18.

Communications network 18 may include one or more local area networks (LANs), metropolitan area networks (MANs), wide area networks (WANs), portions of the Internet, or any other appropriate wireline, optical, wireless, or other links, or any combination thereof. Communications network 18 may, where appropriate, include one or more private networks used exclusively for communication between any of callers 13, agents 14, and call center 12.

Call center 12 may include one or more call routing platforms 64, one or more processors 60, one or more memories 62, and one or more call routers 76, and one or more agents 14. The illustrated configuration of the various components of call center 12 is provided for example purposes only. It should be understood that any suitable configuration may be used. Various components may be integral or discreet and remote or centralized as desired. The grouping of components as subcomponents (e.g., call router 76 and processor 60 as subcomponents of call routing platform 64) is shown for example purposes only. It should be understood that various components may or may not include the subcomponents illustrated in FIG. 1. It should be further understood that various components illustrated as part of call center 12 may exist, in certain embodiments, remote from call center 12. Moreover, the communication links shown in FIG. 1 may be modified as desired. The components of call center 12 may be located at one or more sites and may be coupled to each other using one or more links, each of which may include, for example, some or all of a computer bus, local area networks (LANs), metropolitan area networks (MANs), wide area networks (WANs), portions of the Internet, a public switched telephone network (PSTN), any other appropriate wireline, optical, wireless, or other suitable communication link, or any combination of the preceding.

Call routing platform 64 may include one or more processors 60, one or more memories 62 and one more call routers 76. Routing platform 64 may receive communications from either or both of callers 13 and agents 14. Information transmitted to and from platform 64 may include voice and data. The information may encompass transaction information, customer identification information, agent identification information, transaction criterion, and agent qualifications information. Transaction information may include any information associated with the substance of the transaction being engaged in between a caller and an agent. For example, transaction information may include transaction type, product type, price, date and time information, etc. Transaction data may also include, for example, any information to identify a particular transaction, such as product identification number, product description, call identification number, purchase amount, transaction date and time, transaction identification number, invoice number, etc. Caller identification information may include any information to associate a caller with a transaction. Such information may include, for example, name, address, telephone number, account number, social security number, customer identification number, and password/login names. Agent identification information may include any information for identifying a particular agent and may encompass, for instance, name, employee number, password/login names, etc.

Transaction criterion may include any criterion upon which a decision may be made to connect a particular agent with a particular caller. Transaction criterion may include one or more qualification requirements. In one embodiment, the qualification requirement may be a license requirement. The license may be any type of license including a governmentally-issued license. For example, a license may be an insurance license, a real estate license, a medical license, an engineering license, or a law license. Other types of licenses and certifications are intended to be covered by the scope of this disclosure. The license criterion may be a license of a particular jurisdiction. For example, the jurisdiction may be that of the caller's location, the caller's residence, the agent's location, the call center's location, where the product is being sold, where the product will be used, where the product will be delivered, etc.

The qualification requirement may be any of a number of other types of requirements. For example, the requirement may be a particular level of education, such as high school degree, undergraduate degree, or post-graduate degree. The qualification may be a rating. For example, the rating might be a ranking, a grade point average, or a grade on an exam (such as an exam taken to obtain a license). The rating may be any industry rating or other rating provided by a certification entity. The criterion may include other types of requirements such as proficiency in handling calls, language skills, a jurisdictional requirement, or a location requirement.

The transaction criteria may be specified by the respective caller, or by one or more agents. For example, a caller may use his or her interface for inputting particular criteria which an agent must meet. An appropriate call handling agent is selected at least partially based on the criteria. Similarly, an agent may specify criteria which must be met by a caller, or by another agent. Alternatively, the transaction criteria may be automatically generated by the system based on input. For example, the router or some other element, such as a software module (not expressly shown) may generate transaction criteria. The input may come from a caller, an agent or some other component of system 10.

The transaction criteria may be sent to a plurality of agents for response regardless of whether the respective agents meet the criteria. For example, specified criteria for handling a call may be sent to the interfaces of a plurality of agents. The agents may then make the determination of whether they meet the criteria. If they meet the criteria, they may respond to the associated call, or join a queue of available agents.

In another embodiment, the criteria are only sent to agents that meet the criteria. In this scenario, the system may automatically determine which agents meet the criteria. For example, the call router may receive specified criteria and compare the specified criteria to one or more qualification records, which may be stored, for example, in the memory. The router may determine that a plurality of agents have qualifications that meet the specified criteria. The system may then assign the associated call to one of the qualified agents for handling. For example, the system may send the call to the first available agent of the qualified agents. Alternatively, the system may make the call available to the plurality of agents and allow the agents to determine which agent will handle the call. For example, the first qualified agent to accept the call may be the handling agent. In still another embodiment, the system automatically queues the qualified agents for receiving calls.

In another embodiment, the at least one transaction criterion comprises a plurality of criteria. These criteria may be prioritized according to an order of preference or importance. For example, a caller may be resident in State A and may specify a preference of speaking to an agent whose primary language is English. The system may determine that the one of the transaction criterion is that the handling agent be licensed in State A. The system may further determine that another criterion is that the agent's primary language is English. The system may further determine that the priority of the criteria are the license first and the language second. The system may route the call to an agent based first on the agents licensed in State A and, out of those agents, to an agent that has English as a primary language. Further, it may be determined (e.g., automatically by the system) that one or more of the criteria are mandatory while other criteria are optional. In such a case, the system may prioritize either or both of the mandatory and optional criteria.

Agent qualification information may include any of the same general types of information associated with transaction criteria. The agent qualification information may be stored, for example, in the one or memories of the system. The stored information may be used for comparing and matching the specified transaction criteria to determine how a call will be routed.

Processor 60 may process data associated with callers, agents, transactions, criteria and qualifications. Processor 60 may execute any of the various software modules described herein, and cause data to be stored. The operation of processor 60 may include executing software or coded instructions that may in particular embodiments be associated with the one or more function modules. Processor 60 may be any suitable processor for processing data. Memory 62 may be coupled to processor 60 and may include one or more suitable memory devices, such as one or more random access memories (RAMs), read-only memories (ROMs), dynamic random access memories (DRAMs), fast cycle RAMs (FCRAMs), static RAM (SRAMs), field-programmable gate arrays (FPGAs), erasable programmable read-only memories (EPROMs), electrically erasable programmable read-only memories (EEPROMs), microcontrollers, or microprocessors.

Call routers 76 may be tasked with routing calls based on transaction criteria and qualifications. Routers 76 may receive these pieces of information directly (e.g., from callers or agents), or may access the system's one or more memories to retrieve the information. Routers 76 compare specified transaction criteria with available qualifications (e.g., agent qualifications) to determine how calls will be routed. In at least one example embodiment, router 76 determines that a caller is calling from a particular jurisdiction. This determination may be made using any suitable technology such as Automatic Number Identification. Router 76 may determine that a handling agent must be licensed in the particular jurisdiction. Router 76 may retrieve a plurality of agent qualification records from memory to determine one or more agents meeting the licensing requirement. Router 76 may also determine that from among the plurality of licensed agents, there is a particular agent that is ranked above the other agents according to a secondary criterion. The ranking might be based on any number of factors, such as sales success, sales success in the particular jurisdiction, exam scores, call processing speed, current or projected availability, proficiency, etc. Router 76 determines the best available agent and connects that agent with the caller.

A similar process may be used, for example, in the telemarketing environment. For example, the system may determine that a particular agent is available to handle a call. The system may retrieve the agent's qualification record. The system may determine that the agent should make a call to a prospect based on the qualifications. For example, the available agent may be licensed in three states. System records may indicate that one of the particular states has a highest overall success rate for calls and that the agent has an above-average rating in that particular state. The system may determine that, based on these criteria, the agent should be connected with a prospect in the particular state.

A related business model is to segment a sales force of agents into groups and have each group obtain the necessary qualifications for the group. For example, a group of agents within an agent population might be licensed in one jurisdiction, while a different group is licensed in a different jurisdiction. Jurisdictions might be ranked according to an overall success rate, such as an overall percentage of sales closed compared to sales opportunities. Each agent licensed in the respective jurisdictions may be ranked, both on an overall basis and with respect to particular jurisdictions. The high-overall-success jurisdiction calls may be given to the high-overall-success agents. Out of those agents, the majority of calls may be preferentially routed to agents having the highest success rates in the particular jurisdiction. Thus, higher opportunity calls are routed to higher proficiency agents.

FIG. 2 illustrates an example method 200 for routing calls. At step 202 agent qualifications are determined and stored (e.g., as data records in a memory). At step 204, an incoming call is received. The incoming call may be from a caller such as a customer. The call may alternatively be from an agent or an automated system. At step 206, at least one transaction criterion is specified by the caller. In this example, the caller specifies a primary language. At step 210, the system also species at least one criterion. In this example embodiment, the system determines, at step 208, that the caller is in a particular jurisdiction. Thus, at step 210, the system specifies a criterion that an agent be licensed in caller's jurisdiction. At step 212, the transaction criteria are aggregated and prioritized. As indicated above, a plurality of criteria may be specified and the criteria may be determined as mandatory, non-mandatory, prioritized, etc. As mentioned previously, the criteria may be specified by the caller, an agent or some other component of the call routing system. At step 214, one or more agent qualification records are retrieved. At step 216, the criteria are compared to the qualification records to determine one or more available agents having qualifications meeting the specified criteria. In this embodiment, the determination at step 216 is whether the various agents are licensed in the caller's jurisdiction. At step 218, additional comparisons are made to determine whether the licensed agents meet the specified language requirement. At step 220, the best available agent is determined. For example, this determination may be based on which agent of the licensed and language-qualified agents has the highest ranking (e.g., the highest sales success in the caller's jurisdiction). At step 222, the call is routed to the best available agent for handling. At step 224, the method ends.

It should be understood that this method is an example only and may be modified according to any of the alternative configurations and scenarios discussed in connection with FIG. 1. Further, the method may be utilized in reverse in order to place calls from agents. For instance, the method may be used to place calls to prospective customers directly from the agents or from the system and to be connected with particular agents.

FIG. 3 illustrates another example method 300 for routing calls. At step 302 a first parameter is established. The first parameter may be any parameter associated with conducting a transaction such as a sale of a product. In this example, the first parameter is geographic location. Additional parameters may also be established. Step 304 comprises identifying a plurality of values associated with the first parameter. The value may be a numeric value, an identification, or any other suitable value. In at least certain embodiments, each of the plurality of values is unique compared to each of the other values. In the example, the values are particular geographic locations, such as states.

At step 306, the plurality of values are ranked. The ranking may be accomplished according to any number of methods involving comparing the values. For example, a number may be assigned to each of the values. The numbers may be calculated numeric values, which are calculated according to a predetermined method. The ranking may be accomplished by assigning or determining any type of characteristic for each of the values and then comparing the characteristics. In the example, a success rate is determined for each of the states. The success rate may be a sales success rate for the plurality of agents with respect to each of the given states.

At step 308, an overall rate is determined. The overall rate is associated with the first parameter. In the example, the overall rate is the overall success rate of the plurality of agents in the entire group of states.

At step 310, a first subrate of a first subset of the plurality of agents is determined. The first subrate is associated with a first subset of the plurality of values. In the example, the first subset of agents comprises one agent and the first subset of values comprises one state. The first subrate is determined as the success rate for that particular agent in the particular state. This can be done for each of the agents in each of the states.

At step 312, a call is routed to an agent based on the first subrate. For example, the first subrate may be compared to other similarly calculated subrates and the call may be routed to the agent having the highest subrate. At step 314, the method ends. As with other embodiments, it should be understood that this method is an example only and modifications consistent with the disclosure are encompassed by the invention.

Modifications, additions, or omissions may be made to the method without departing from the scope of the invention. Additionally, steps may be performed in any suitable order without departing from the scope of the invention.

Although an embodiment of the invention and its advantages are described in detail, a person skilled in the art could make various alterations, additions, and omissions without departing from the spirit and scope of the present invention as defined by the appended claims.

1. A call routing system, comprising:
at least one processor;
at least one memory electronically coupled to the processor, the at least one memory operable to store agent data indicative of one or more qualifications of a plurality of agents;
at least one call router operable to route calls with callers to one or more of the plurality of agents based on at least one transaction criterion associated with the respective calls, the at least one call router operable to match the at least one transaction criterion to agent data of at least one of the plurality of agents having at least one qualification corresponding to and meeting the at least one transaction criterion.

2. The system of claim 1, wherein the at least one transaction criterion is associated with a transaction between a customer and an agent.

3. The system of claim 2, wherein the at least one transaction criterion is based on the type of transaction.

4. The system of claim 1, wherein the at least one transaction criterion is based on a product being sold during the respective call.

5. The system of claim 1, wherein the at least one transaction criterion comprises a requirement that an agent have a particular license.

6. The system of claim 5, wherein the license is associated with a product being sold during a call.

7. The system of claim 5, wherein the license is associated with a jurisdiction in which a respective caller is located during the call.

7. The system of claim 5, wherein the license is associated with a jurisdiction in which a respective caller is resident.

8. The system of claim 5, wherein the license is associated with a jurisdiction in which a respective agent is located.

9. The system of claim 5, wherein the license is associated with a jurisdiction in which a call center of a respective agent is located.

10. The system of claim 5, wherein the license is a license to sell insurance.

11. The system of claim 5, wherein the license is a license to sell real estate.

12. The system of claim 5, wherein the license is a license to practice law.

13. The system of claim 5, wherein the license is a license to practice medicine.

14. The system of claim 5, wherein the at least one transaction criterion further comprises a rating associated with obtaining the license.

15. The system of claim 14, wherein the rating is an exam grade.

16. The system of claim 1, wherein the at least one transaction criterion comprises that the agent have a predetermined language skill.

17. The system of claim 1, wherein the at least one transaction criterion comprises an agent's call processing speed.

18. The system of claim 1, wherein the at least one transaction criterion comprises a scholastic educational level.

19. The system of claim 1, wherein the at least one transaction criterion comprises a scholastic grade point average.

20. The system of claim 1, wherein the at least one transaction criterion is specified by a caller.

21. The system of claim 1, wherein the at least one transaction criterion is automatically generated by the system in response to input.

22. The system of claim 21, wherein the input is provided by a caller.

23. The system of claim 21, wherein the input is provided by an agent.

24. The system of claim 1, wherein the at least one criterion is sent to a plurality of agents regardless of whether the respective agents meet the criterion, and wherein respective agents determine if they meet the at least one criterion.

25. The system of claim 1, wherein the system automatically determines which of the plurality of agents meets the at least one criterion, and wherein the at least one criterion is sent to a plurality of agents for a determination of which of the plurality of agents will handle the respective call.

26. The system of claim 1, wherein the system automatically determines which of the plurality of agents meets the at least one criterion, and wherein the system queues respective qualified agents for handling to the respective call.

27. The system of claim 1, wherein the at least one transaction criterion comprises a plurality of criteria.

28. The system of claim 27, wherein the plurality of criteria is prioritized according to levels of importance, and wherein an agent is selected to handle the respective call based on the prioritized criteria.

29. The system of claim 27, wherein at least one of the plurality of criteria is mandatory and wherein the other criteria are optional, and wherein the system queues respective agents meeting the at least one mandatory criterion.

30. The system of claim 29, wherein the non-mandatory criteria are prioritized.

31. A method of routing calls, comprising:
receiving a first transaction criterion;
comparing the first transaction criterion to one or more stored qualification records associated with one or more agents;
determining, according to the one or more qualification records, which of the one or more agents meets the first transaction criterion,
determining which agent, from among the agents meeting the first criterion, has a highest rating; and
routing a call to the highest-rated agent meeting the first criterion.

32. The method of claim 31, wherein the first criterion is a license requirement.

33. The method of claim 32, wherein the license requirement is associated with a location of a caller making the incoming call.

34. The method of claim 32, wherein the license requirement is associated with a residence of a caller connected on the call.

35. The method of claim 31, wherein the first criterion is specified by a caller connected on the call.

36. The method of claim 31, wherein the first criterion is specified by an agent.

37. The method of claim 31, wherein the first criterion is determined by a call routing system based on input.

38. The method of claim 37, wherein the input is provided by a caller connected on the call.

39. The method of claim 37, wherein the input is a caller's telephone number and wherein the call routing system determines a license requirement based on a jurisdiction associated with the telephone number.

40. The method of claim 31, further comprising receiving a plurality of transaction criteria and prioritizing the transaction criterion, and routing the call based on the prioritized transaction criteria.

41. The method of claim 31, further comprising receiving a plurality of transaction criteria and determining at least one mandatory criterion and at least one optional criterion from the plurality of transaction criteria.

42. The system of claim 41, wherein the call is connected as an outgoing call to a customer from an agent.

43. The system of claim 41, wherein the call is connected as an incoming call from a customer to an agent.

44. A method for routing calls, comprising:
automatically determining a jurisdiction of a caller;
automatically determining a license requirement associated with the jurisdiction;
automatically identifying, from a plurality of agents, one or more agents meeting the licensing requirement; and
automatically routing the call to one of the one or more agents meeting the licensing requirement.

45. The method of claim 44, further comprising determining, from among the licensed agents, which agent has a highest rating, and routing the call to the highest-rated, licensed, agent.

46. A method of routing calls, comprising:
establishing a first parameter;
identifying a plurality of values associated with the first parameter;
ranking the plurality of values;
determining an overall rate of a plurality of agents, the overall rate being associated with the first parameter;
determining a first subrate of a first subset of the plurality of agents, the first subrate being associated with a first subset of the plurality of values; and
routing a call to an agent among the first subset of agents based on the first subrate.

47. The method of claim 46, wherein the first parameter comprises geographic location.

48. The method of claim 46, wherein the plurality of values comprises a plurality of identified geographic locations.

49. The method of claim 46, wherein the plurality of values comprises a plurality of identified jurisdictions.

50. The method of claim 46, wherein the plurality of values comprises a plurality of states.

51. The method of claim 46, wherein the overall rate comprises an overall success rate for the plurality of agents in a plurality of geographic areas.

52. The method of claim 51, wherein the first subrate is a success rate for at least one first agent of the plurality of agents in at least one of the plurality of geographic areas.

53. The method of claim 52, further comprising a second subrate of at least one second agent and determining which of the first and second subrates is higher.

54. The method of claim 53, further comprising routing the call to the agent having the higher subrate.

55. The method of claim 46 further comprising determining a second subrate, comparing the second subrate to the first subrate, and routing the call to an agent based on the comparison.

56. The method of claim 46, wherein the first subset of agents comprises one agent.

57. The method of claim 46, wherein the first subset of values comprises one value.

58. A method of routing calls, comprising:
establishing a first plurality of values associated with a first parameter;
establishing a second plurality of values associated with a second parameter;
associating the second plurality with the first plurality to determine an overall rate;
associating a first subset of the second plurality with a first subset of the first plurality to determine a first subrate;
comparing the first subrate to the overall rate; and
routing a call based on the comparison.
